(19) United States
(12) Patent Application Publication
(10) Pub. No.: US 2023/0216894 A1
(43) Pub. Date: Jul. 6, 2023

(54) SYSTEM AND METHODS FOR REAL-TIME DATA BAND MULTI-PATH ROUTING

(71) Applicant: Citrix Systems, Inc., Fort Lauderdale, FL (US)

(72) Inventor: Santosh Kumar Swain, Bangalore (IN)

(73) Assignee: Citrix Systems, Inc., Fort Lauderdale, FL (US)

(21) Appl. No.: 17/569,793

(22) Filed: Jan. 6, 2022

(51) Int. Cl. H04L 65/1069; H04L 45/24; H04L 67/06

(52) U.S. Cl. CPC H04L 65/1069; H04L 45/24; H04L 67/06

(57) ABSTRACT

Systems and methods for real-time data band multi-path routing include a device determining a first designation for a first point of presence (POP) and a second designation for a second POP. The first POP and the second POP are intermediary to a client device and an endpoint. The device selects, based on the first designation or the second designation and network traffic for transmitting to the endpoint, a first connection to the first POP or a second connection to the second POP. The device transmits the network traffic between the client device and the endpoint, via the selected first connection or second connection.

### FIELD OF THE DISCLOSURE

The present application generally relates to networking, including but not limited to systems and methods for real-time data band multi-path routing.

### BACKGROUND

Various services may be used, accessed, or otherwise provided to users via their respective client devices. Some services may be accessed via a virtual delivery session from a remote endpoint or server. Data may be transmitted via a dedicated channel or connection for the virtual delivery session between the client device and the remote endpoint or server.

### SUMMARY

This Summary is provided to introduce a selection of concepts in a simplified form that is further described below in the Detailed Description. This Summary is not intended to identify key features or essential features, nor is it intended to limit the scope of the claims included herewith.

In various systems, when a user accesses or otherwise launches a virtualized delivery session on a client or client device, the client may retrieve or otherwise obtain an architecture or session file (such as in independent computing architecture (ICA) file). Once the client receives the session file, the client (such as a workspace application of the client) may establish a connection with the nearest (e.g., geographically closest) gateway service point of presence (POP). The gateway service POP (generally referred to herein as a “POP”) may establish a tunnel (such as a transmission control protocol (TCP) or enlightened data transport (EDT) tunnel or connection) from the client to an endpoint for the virtualized delivery session (which may be a data center). Following establishing the tunnel, the session may be statically associated with the tunnel such that virtualized data for all user activity (e.g., mouse movement, screen refresh, file transfers, printer/USB data flow, etc.) exchanged between the client and the endpoint occurs in a monolithic fashion on the established tunnel. This flow of traffic may result in degradation of user experience, increased latency, overloading of particular POPs, etc.

For example, in certain occasions due to higher traffic intensive virtualized application usage by multiple users simultaneously, and all the users being served on a single POP resource instance, the data throughput on that POP may increase beyond a threshold. As a result, a network driver for the POP may intentionally drop packets, which in turn results in retransmits between the clients and endpoint. This outcome may yield a poor user experience, even if a POP has the required resource allocated at a different time instance, due in part because of all session data being transmitted on a single established tunnel. Additionally, since the single connection-based data transmission is all sent on the underlying TCP/EDT connection, the session quality may be directly correlated to the connection or channel health, where a malfunction or latency by any network device or POP in the path affects the user experience and sometimes result a disruption for reconnect when the connection goes down. For example, any failure to the connection serving POP or resource instance results a complete failure for the user session, and ultimately the user has to re-access the application.

Additionally, since routing logic in the clients causes the clients to establish a connection or channel to the closet located POP, which ultimately establishes a connection to a corresponding endpoint, connections established during working hours for a particular geographic location may result in all channels being routed to a single POP (or set of POPs). On the other hand, POPs which are not near that geographic location (and may serve other geographic locations) may be idle or serving minimal traffic mainly due that POP operating in non-working hours for that particular geographic location. For example, during working hours in the United States, POPs in the United States may be handling all connections or channels originating in the United States and therefore may be overloaded, while POPs in Asia/Australia/Europe may be serving minimal traffic because these geographic locations are outside of working hours.

In at least some embodiments of the present solution, a client device may determine a first designation for a first point of presence (POP) and a second designation for a second POP. The first and second POP may be intermediary to the client device and an endpoint. The client device may select a first connection to the first POP or a second connection to the second POP based on the first designation or the second designation and network traffic for transmitting to the endpoint. The client device may transmit the network traffic from the client device to the endpoint via the selected first connection or the second connection.

According to the systems and methods of the present solution, the systems and methods described herein may distribute traffic across different connections or channels, such that the most critical (e.g., real-time) virtualized data being served on the closet POP, whereas the associated non-real-time data can be served via other POP(s) which are serving minimal loads. For example, a cloud services may provide in a session file for a given endpoint stack, and define different logical virtual data unit (VDU) groupings (like: mouse movement, keyboard interaction, screen refresh, analytics, printer, USB, file copy, etc.) for the virtualized data. The virtual data units may be used both by the client device and/or endpoint for separating network traffic (or data flow) into different streams/connections which are transmitted to different POPs in a parallel manner. For example, the client device (or a workspace application of the client device) and an endpoint (such as a server, or virtualized delivery endpoint) (collectively referred to herein as “devices”) may define at least two bands/channels/connections for transmitting, receiving, or otherwise exchanging network traffic or virtualized data. The devices may use one connection (or one set of connections) for serving a first type of network traffic (such as real-time network traffic) and another connection (or another set of connections) for serving a second type of network traffic (such as non-real time traffic).

The devices may inspect network traffic and use the VDU groupings for selecting which connection/connections to use for serving the network traffic. For example, network traffic having data units which are classified or grouped as real-time may be transmitted over the real-time data band(s) or channel(s), and similarly network traffic having data units which are classified or grouped as non-real-time may be sent over the non-real-time data band(s) or channels. The data units may be classified or grouped as non-real-time because the data may not have an impact on the user experience or may be sent in an asynchronous manner. As a brief example, for any launched session, the VDUs (mouse movement, keyboard interaction, screen refresh, etc.) can be treated as a real time data whereas data groups (like analytics data, printer data, etc.) can be over non-real-time data band. Considering operations like file transfer over a particular session which often times involves user experience, but based on the transmission logic where the file data gets streamed continuously to the peer without waiting for an acknowledgment (ACK) and selective retransmission, the file transfer may be transmitted over the non-real-time band(s) or channel(s). Similarly, keep alive messages, which do not have any user experience impact, may also be transmitted via the non-real-time data band(s) or channel(s).

According to the embodiments of the present solution, the systems and methods described herein may leverage POPs across multiple geographic locations to ensure that user experience is not degraded while load balancing across the POPs through selective designation of POPs and selecting connections based on the designation and the network traffic. Rather than transmitting or transferring all data via a single connection or channel to the nearest POP, the systems and methods of the present solution may selectively transmit network traffic via a particular connection to a particular POP based on a determined designation for the POP and the network traffic which is to be transmitted to an endpoint. This decreases the likelihood of overloaded POPs by spreading network traffic across different POPs, while ensuring that user experience is maintained by transmitting (for example) real-time network traffic to geographically closest POPs.

In one aspect, this disclosure is directed to a method. The method may include determining, by a client device, a first designation for a first point of presence (POP) and a second designation for a second POP, the first POP and the second POP intermediary to the client device and an endpoint. The method may include selecting, by the client device, based on the first designation or the second designation and network traffic for transmitting to the endpoint, a first connection to the first POP or a second connection to the second POP. The method may include transmitting, by the client device, the network traffic from the client device to the endpoint, via the selected first connection or second connection.

In some embodiments, the method further includes receiving, by the client device from a cloud service, a data file including the first designation for the first POP and the second designation for the second POP, wherein determining the first designation for the first POP and the second designation for the second POP is based on the data file. In some embodiments, the network traffic includes first network traffic having a first traffic type. The method may further include receiving, by the client device from the endpoint, second network traffic via one of the first connection or the second connection, the endpoint selecting one of the first POP or the second POP based on a second traffic type of the second network traffic. In some embodiments, the method further includes establishing the first connection to the first POP and the second connection to the second POP. Establishing the first connection and the second connection may include transmitting, by the client device, a session identifier and the first designation to the first POP, the first POP establishing a corresponding third connection with the endpoint and transmitting the first designation to the endpoint via the third connection. Establishing the first connection and the second connection may include transmitting, by the client device, the session identifier and the second designation to the second POP, the second POP establishing a corresponding fourth connection with the endpoint and transmitting the second designation to the endpoint via the fourth connection. In some embodiments, the endpoint transmits second network traffic via the third connection or fourth connection to the client device based on a second traffic type of the second network traffic.

In some embodiments, the first POP comprises a plurality of first POPs having the first designation and the second POP comprises a plurality of second POPs having the second designation. The method may further include establishing, by the client device, a plurality of first connections to the plurality of first POPs and a plurality of second connections to the plurality of second POPs. In some embodiments, the method further includes selecting, by the client device, the first connection of the plurality of first connections based on at least one of i) one or more metrics of the first connection, ii) a connection status of the first connection, iii) a round robin of the plurality of first connections; or iv) a message to cause the client device to switch to the first connection. In some embodiments, the method further includes determining, by the client device, the traffic type of the network traffic, and selecting, by the client device, the first connection or the second connection for transmitting the network traffic based on the determined traffic type. In some embodiments, the determined traffic type includes at least one of real-time network traffic or non-real-time network traffic. In some embodiments, the method further includes identifying, by the client device, a first set of data units having a first traffic type and a second set of data units having a second traffic type. The method may further include transmitting, by the client device, first data of the network traffic via the first connection based on determining that the first data is of the first set of data units. The method may further include transmitting, by the client device, second data of the network traffic via the second connection based on determining that the second data is of the second set of data units.

In another aspect, this disclosure is directed to a client device. The client device includes one or more processors configured to determine a first designation for a first point of presence (POP) and a second designation for a second POP, the first POP and the second POP intermediary to the client device and an endpoint. The one or more processors are configured to select, based on the first designation or the second designation and network traffic for transmitting to the endpoint, a first connection to the first POP or a second connection to the second POP. The one or more processors are configured to transmit the network traffic from the client device to the endpoint, via the selected first connection or second connection.

In some embodiments, the one or more processors are further configured to receive, from a cloud service, a data file including the first designation for the first POP and the second designation for the second POP, wherein determining the first designation for the first POP and the second designation for the second POP is based on the data file. In some embodiments, the network traffic comprises first network traffic having a first traffic type, and the one or more processors are further configured to receive, from the endpoint, second network traffic via one of the first connection or the second connection, the endpoint selecting one of the first POP or the second POP based on a second traffic type of the second network traffic. In some embodiments, the one or more processors are further configured to establish the first connection to the first POP and the second connection to the second POP. Establishing the first connection and the second connection may include transmitting a session identifier and the first designation to the first POP, the first POP establishing a corresponding third connection with the endpoint and transmitting the first designation to the endpoint via the third connection. Establishing the first connection and the second connection may include transmitting the session identifier and the second designation to the second POP, the second POP establishing a corresponding fourth connection with the endpoint and transmitting the second designation to the endpoint via the fourth connection. In some embodiments, the endpoint transmits second network traffic via the third connection or fourth connection to the client device based on a second traffic type of the second network traffic.

In some embodiments, the first POP comprises a plurality of first POPs having the first designation and the second POP comprises a plurality of second POPs having the second designation. The one or more processors may be further configured to establish a plurality of first connections to the plurality of first POPs and a plurality of second connections to the plurality of second POPs. In some embodiments, the one or more processors are further configured to select the first connection of the plurality of first connections based on at least one of i) one or more metrics of the first connection, ii) a connection status of the first connection, iii) a round robin of the plurality of first connections; or iv) a message to cause the client device to switch to the first connection. In some embodiments, the one or more processors are further configured to determine the traffic type of the network traffic, the determined traffic type comprising at least one of real-time network traffic or non-real-time network traffic, and select the first connection or the second connection for transmitting the network traffic based on the determined traffic type. In some embodiments, the one or more processors are further configured to identify a first set of data units having a first traffic type and a second set of data units having a second traffic type. The one or more processors may be further configured to transmit first data of the network traffic via the first connection based on determining that the first data is of the first set of data units, and transmit second data of the network traffic via the second connection based on determining that the second data is of the second set of data units.

In yet another aspect, this disclosure is directed to a non-transitory computer readable medium storing instructions that, when executed by one or more processors, cause the one or more processors to determine a first designation for a first point of presence (POP) and a second designation for a second POP, the first POP and the second POP intermediary to the client device and an endpoint. The instructions further cause the one or more processors to select, based on the first designation or the second designation and network traffic for transmitting to the endpoint, a first connection to the first POP or a second connection to the second POP. The instructions further cause the one or more processors to transmit the network traffic from the client device to the endpoint, via the selected first connection or second connection.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, with emphasis instead being placed upon illustrating embodiments, principles, and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIG. 5 is a block diagram of a system for real-time data band multi-path routing, in accordance with an illustrative embodiment;

FIG. 6 is an example of a computing environment following establishing connections between the client device and endpoint shown in FIG. 5, in accordance with an illustrative embodiment.

FIG. 7 is a flow diagram showing a method of real-time data band multi-path routing, in accordance with an illustrative embodiment

### DETAILED DESCRIPTION

In various systems, when a user accesses or otherwise launches a virtualized delivery session on a client or client device, the client may retrieve or otherwise obtain an architecture or session file (such as in independent computing architecture (ICA) file). Once the client receives the session file, the client (such as a workspace application of the client) may establish a connection with the nearest (e.g., geographically closest) gateway service point of presence (POP). The gateway service POP (generally referred to herein as a “POP”) may establish a tunnel (such as a transmission control protocol (TCP) or enlightened data transport (EDT) tunnel or connection) from the client to an endpoint for the virtualized delivery session (which may be a data center). Following establishing the tunnel, the session may be statically associated with the tunnel such that virtualized data for all user activity (e.g., mouse movement, screen refresh, file transfers, printer/USB data flow, etc.) exchanged between the client and the endpoint occurs in a monolithic fashion on the established tunnel. This flow of traffic may result in degradation of user experience, increased latency, overloading of particular POPs, etc.

For example, in certain occasions due to higher traffic intensive virtualized application usage by multiple users simultaneously, and all the users being served on a single POP resource instance, the data throughput on that POP may increase beyond a threshold. As a result, a network driver for the POP may intentionally drop packets, which in turn results in retransmits between the clients and endpoint. This outcome may yield a poor user experience, even if a POP has the required resource allocated at a different time instance, due in part because of all session data being transmitted on a single established tunnel. Additionally, since the single connection-based data transmission is all sent on the underlying TCP/EDT connection, the session quality may be directly correlated to the connection or channel health, where a malfunction or latency by any network device or POP in the path affects the user experience and sometimes result a disruption for reconnect when the connection goes down. For example, any failure to the connection serving POP or resource instance results a complete failure for the user session, and ultimately the user has to re-access the application.

Additionally, since routing logic in the clients causes the clients to establish a connection or channel to the closet located POP, which ultimately establishes a connection to a corresponding endpoint, connections established during working hours for a particular geographic location may result in all channels being routed to a single POP (or set of POPs). On the other hand, POPs which are not near that geographic location (and may serve other geographic locations) may be idle or serving minimal traffic mainly due that POP operating in non-working hours for that particular geographic location. For example, during working hours in the United States, POPs in the United States may be handling all connections or channels originating in the United States and therefore may be overloaded, while POPs in Asia/Australia/Europe may be serving minimal traffic because these geographic locations are outside of working hours.

In at least some embodiments of the present solution, a client device may determine a first designation for a first point of presence (POP) and a second designation for a second POP. The first and second POP may be intermediary to the client device and an endpoint. The client device may select a first connection to the first POP or a second connection to the second POP based on the first designation or the second designation and network traffic for transmitting to the endpoint. The client device may transmit the network traffic from the client device to the endpoint via the selected first connection or the second connection.

According to the systems and methods of the present solution, the systems and methods described herein may distribute traffic across different connections or channels, such that the most critical (e.g., real-time) virtualized data being served on the closest POP, whereas the associated non-real-time data can be served via other POP(s) which are serving minimal loads. For example, a cloud services may provide in a session file for a given endpoint stack, and define different logical virtual data unit (VDU) groupings (like: mouse movement, keyboard interaction, screen refresh, analytics, printer, USB, file copy, etc.) for the virtualized data. The virtual data units may be used both by the client device and/or endpoint for separating network traffic (or data flow) into different streams/connections which are transmitted to different POPs in a parallel manner. For example, the client device (or a workspace application of the client device) and an endpoint (such as a server, or virtualized delivery endpoint) (collectively referred to herein as “devices”) may define at least two bands/channels/connections for transmitting, receiving, or otherwise exchanging network traffic or virtualized data. The devices may use one connection (or one set of connections) for serving a first type of network traffic (such as real-time network traffic) and another connection (or another set of connections) for serving a second type of network traffic (such as non-real time traffic).

The devices may inspect network traffic and use the VDU groupings for selecting which connection/connections to use for serving the network traffic. For example, network traffic having data units which are classified or grouped as real-time may be transmitted over the real-time data band(s) or channel(s), and similarly network traffic having data units which are classified or grouped as non-real-time may be sent over the non-real-time data band(s) or channels. The data units may be classified or grouped as non-real-time because the data may not have an impact on the user experience or may be sent in an asynchronous manner. As a brief example, for any launched session, the VDUs (mouse movement, keyboard interaction, screen refresh, etc.) can be treated as a real time data whereas data groups (like analytics data, printer data, etc.) can be over non-real-time data band. Considering operations like file transfer over a particular session which often times involves user experience, but based on the transmission logic where the file data gets streamed continuously to the peer without waiting for an acknowledgment (ACK) and selective retransmission, the file transfer may be transmitted over the non-real-time band(s) or channel(s). Similarly, keep alive messages, which do not have any user experience impact, may also be transmitted via the non-real-time data band(s) or channel(s).

According to the embodiments of the present solution, the systems and methods described herein may leverage POPs across multiple geographic locations to ensure that user experience is not degraded while load balancing across the POPs through selective designation of POPs and selecting connections based on the designation and the network traffic. Rather than transmitting or transferring all data via a single connection or channel to the nearest POP, the systems and methods of the present solution may selectively transmit network traffic via a particular connection to a particular POP based on a determined designation for the POP and the network traffic which is to be transmitted to an endpoint. This decreases the likelihood of overloaded POPs by spreading network traffic across different POPs, while ensuring that user experience is maintained by transmitting (for example) real-time network traffic to geographically closest POPs.

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for providing a clustered appliance architecture environment;

Section D describes embodiments of systems and methods for providing a clustered appliance architecture environment; and

Section E describes embodiments of systems and methods for real-time data band multi-path routing.

### A. Network and Computing Environment

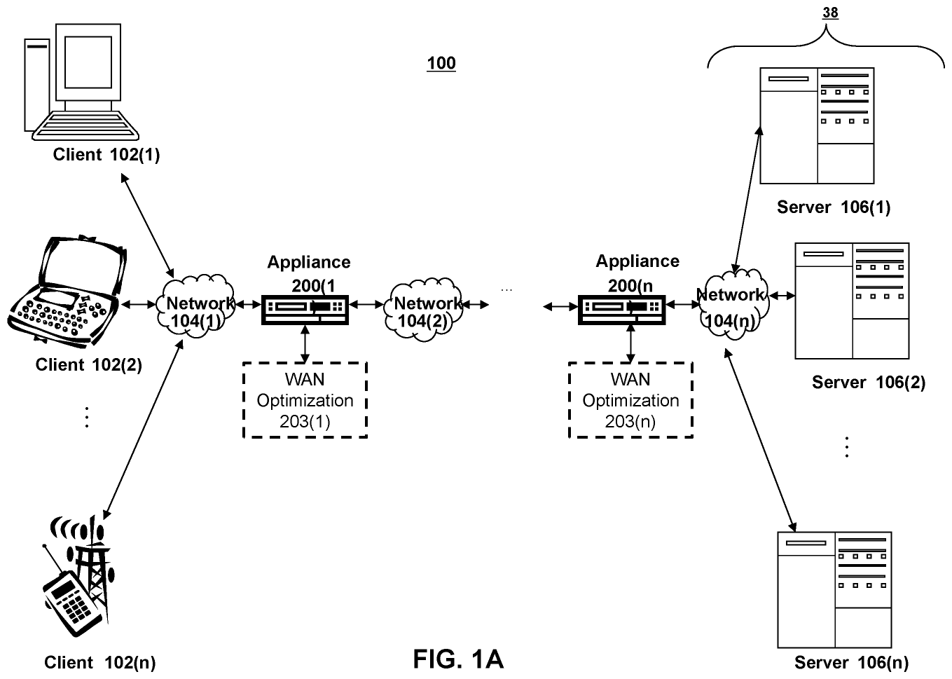

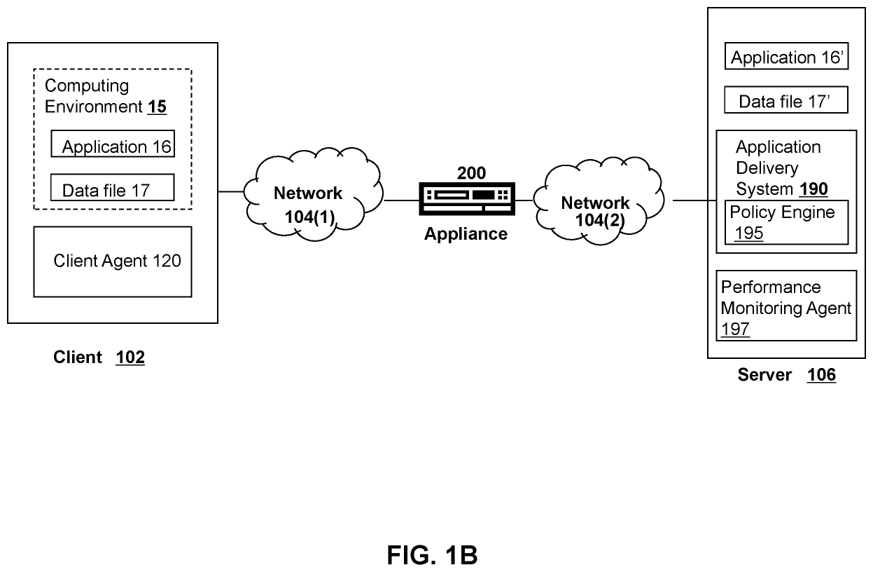

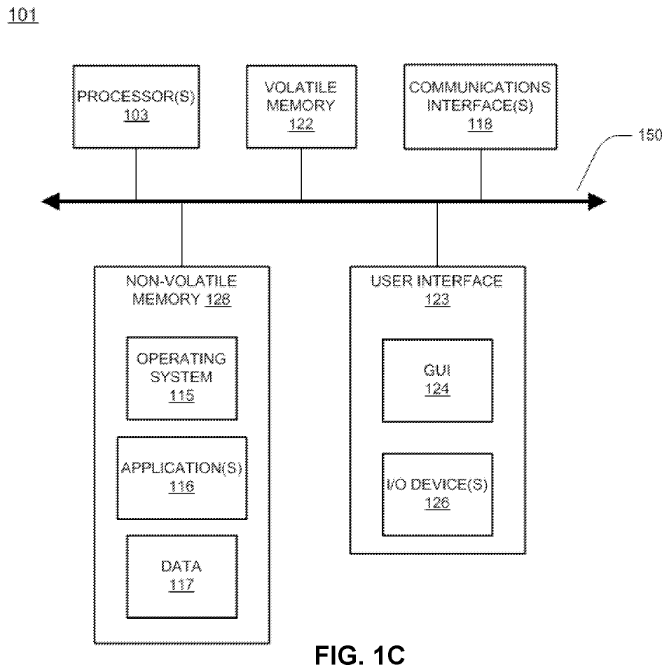

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, Fla.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. In some embodiments, the WAN optimization appliance(s) 205 may be used for optimizing a software-defined WAN (SD-WAN). For example, WAN optimization appliance 205 may accelerate, cache, compress or otherwise optimize or improve performance, operation, flow control, or quality of service of network traffic, such as traffic to and/or from a WAN (or SD-WAN) connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, Fla.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, Fla. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS), platform as a service (PaaS), a CITRIX managed desktop service (CMD service) or a CITRIX virtual applications and desktops service (CVAD service).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, Fla.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

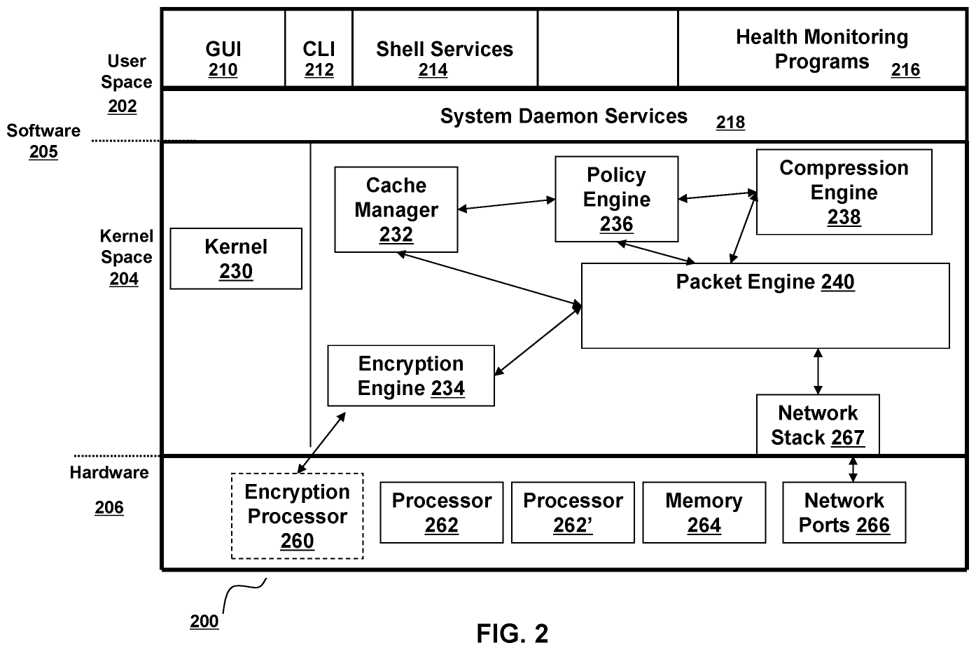

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, Fla. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Virtualizing an Application Delivery Controller

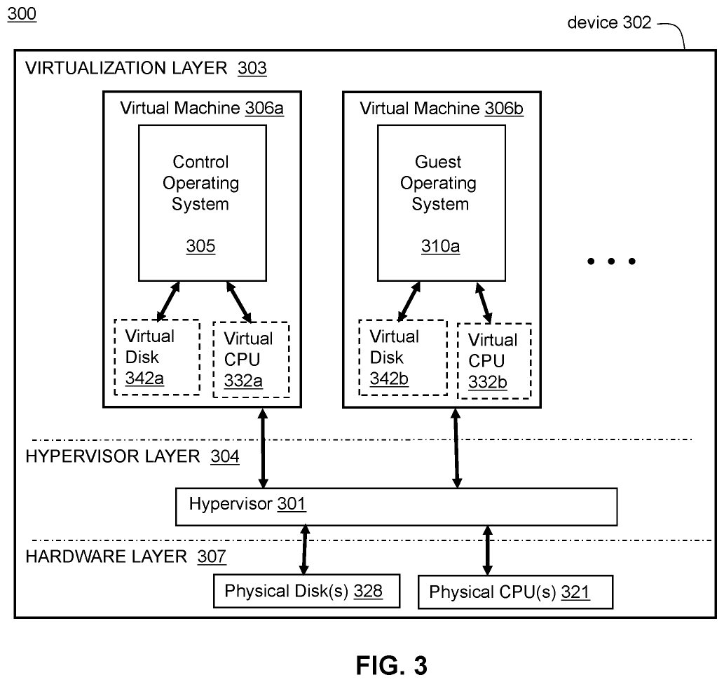

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, Fla. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

### D. Systems and Methods for Providing a Distributed Cluster Architecture

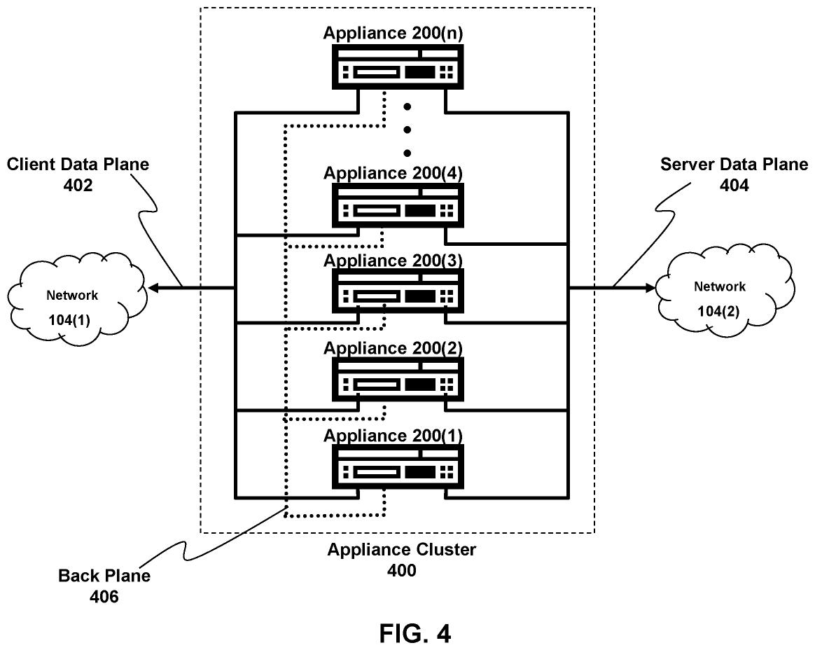

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a first network 104(1) via client data plane 402, for example to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104(2) via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

### E. Systems and Methods for Real-Time Data Band Multi-Path Routing

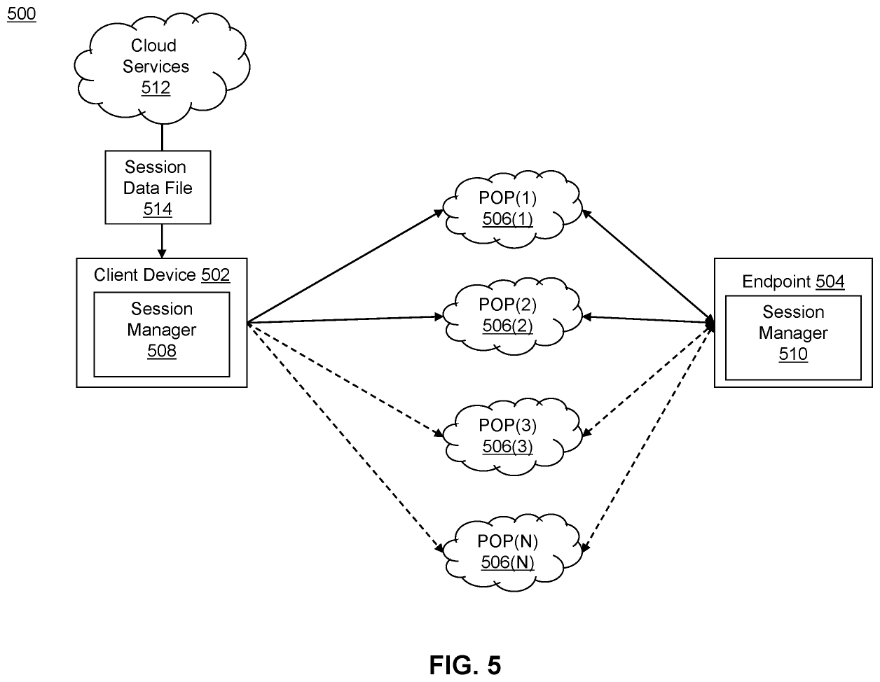

Referring now to FIG. 5, depicted is a system 500 for real-time data band multi-path routing, according to an illustrative embodiment. The system 500 is shown to include a client device 502, an endpoint 504, and a plurality of points of presence (POPs) 506 intermediary to the client device 502 and the endpoint 504. When the client device 502 establishes a session (such as a virtual delivery session) with the endpoint 504, a session manager 508 of the client device 502 may be configured to determine a designation for the POPs 506. The session manager 508 may be configured to select connections between the POPs 506 based on the designation for the POPs 506 and network traffic for transmitting to the endpoint 504. The session manager 508 may be configured to transmit network traffic from the client device 502 to the endpoint 504 via the selected connection. Similarly, a session manager 510 of the endpoint 504 may determine designations of the POPs 506 based on data received from the client deice 502 via the respective POPs 506 (e.g., responsive to the POPs 506 establishing corresponding connections with the endpoint 504). The session manager 510 may be configured to select connection between the POPs 506 based on the designation for the POPs 506 and network traffic for transmitting to the client device 502. The session manager 510 may be configured to transmit network traffic from the endpoint 504 to the client device 502 via the selected connection.

The devices and components shown in FIG. 5 may be similar to the devices/components described above with reference to FIG. 1A—FIG. 4. For example, the client device 502 and endpoint 504 may be similar to the client(s) 102 and server(s) 106 described above with reference to FIG. 1A and FIG. 1B. The POPs 506 may be similar to the appliances 200 described above with reference to FIG. 1A-FIG. 2 and FIG. 4. In some embodiments, the client device 502 may be similar to the computing device 302 described above with reference to FIG. 3. For example, the client device 502 may be configured to establish a virtualized environment as described above with reference to FIG. 3. The virtualized environment may be used to access one or more virtualized applications or resources hosted on the endpoint 504. For example, and as described above with reference to FIG. 2, a remote user may obtain a computing environment and access to server or endpoint 504 stored applications and data files from any network-connected device (e.g., from the client device 502). For example, when the user initiates a session with the endpoint 504, the client device 502 may route requests via one or more of the POPs 506 to receive application and data file(s) from the endpoint 504. In response to the request, an application delivery system and/or the endpoint 504 may deliver the application and data files to the client device 502, for example via an application stream to operate in a computing environment on the client device 502, or via a remote-display protocol or otherwise via remote-based or server-based computing.

The client device 502 and endpoint 504 are shown to include respective session managers 508, 510. The session managers 508, 510 may be or include any devices, components, elements, or other combination of hardware configured to manage a session between the client device 502 and endpoint 504. For example, the session managers 508, 510 may be configured to manage a flow of network traffic across different channels or connections between the client device 502 and endpoint 504. As described in greater detail below, the session manager 508, 510 may be configured to manage a flow of network traffic based on, for example, a network traffic type for network traffic and a corresponding designation for POPs 506 intermediary to the client device 502 and endpoint 504.

The system 500 is shown to include cloud services 512. The cloud services 512 may be or include any devices, servers, components, or other hardware configured to manage sessions for a plurality of client devices (including the client device 502). The cloud services 512 may be configured to maintain data corresponding to each of the POPs 506. For example, the cloud services 512 may be configured to maintain data corresponding to a location of the POPs 506 (e.g., a geographic location), a current or target throughput for the POPs 506, etc.

The cloud services 512 may be configured to maintain or otherwise access service data and one or more designation rules for assigning a designation for the POPs 506. In some embodiments, the cloud services 512 may be configured to receive the service data and designation rules from an administrator computing device (e.g., at deployment of the cloud services 512). The cloud services 512 may be configured to receive update(s) to the service data and designation rules (or updated designation rules) responsive to deployment of new POPs 506, responsive to removing an existing POP 506, etc. The service data may include, for example, a location for a respective POP 506, a service provider for the POP 506, peak time duration for the POP 506, off-peak time duration for the POP 506, etc.

The designation rules may include, for example, rules for associating a particular location (e.g., of a client device 502) and timestamp from a query with corresponding designations for POPs 506. The designation rules may include a first rule for determining a location of POPs 506 which are closest to (e.g., geographically located nearest to) the client device 502. The first rule may cause the cloud services 512 to assign a first designation (e.g., real-time traffic designation) to one or more first POPs 506 which are closest in proximity to the client device 502. The designation rules may include a second rule for assigning designations for each (or a subset) of the POPs 506 based on a comparison of a timestamp of a query from a client device 502 to a peak hour time duration for each POP 506. For instance, where the timestamp of a query from a client device 502 is within a peak hour time duration for the first POP 506, the second rule may cause the cloud services 512 to assign a second designation (e.g., non-real-time traffic designation) to one or more second POPs 506. As described in greater detail below, the first and second designations may cause the client device 502 and/or endpoint 504 to route network traffic via different POPs 506 based on their respective designations. For example, where the timestamp of a query from a client device 502 is within a peak hour time duration for the first POP 506, the client device 502 and endpoint 504 may route real-time network traffic between the client device 502 and endpoint 504 via the one or more first POPs 506 (e.g., having the first designation) and route non-real-time network traffic between the client device 502 and endpoint via the one or more second POPs 506 (e.g., having the second designation). On the other hand, where the timestamp of a query is outside of the peak hour time duration for the first POP 506, the client device 502 and endpoint 504 may route both real-time and non-real-time network traffic between the client device 502 and endpoint 504 via the one or more first POPs 506 (having the first designation).

The cloud services 512 may be configured to receive, for example, requests from a workspace application, a session manager 508, 510, or other resource on the client device 502 for establishing a session with an endpoint 504. For instance, when a user launches a virtualized application or otherwise requests a session with the endpoint 504, the session manager 508 may be configured to generate a query for the cloud services 512. The query may be, for example, a fully qualified domain name (FQDN) query to identify POPs 506 to which the client device 502 is to establish connections for the session. The query may include, for example, an identifier or address of the endpoint 504, a location (e.g., a geographic location) or data corresponding to the location of the client device 502, a timestamp, etc. The session manager 508 may be configured to transmit the query to the cloud services 512.

The cloud services 512 may be configured to receive the query from the client device 502. The cloud services 512 may be configured to analyze, determine, extract, or otherwise identify the location associated with the client device 502 and the timestamp. The cloud services 512 may be configured to select, generate, identify, assign, or otherwise determine a designation for the POPs 506 based on the location associated with the client device 502 and the timestamp from the query. In some embodiments, the cloud services 512 may be configured to determine the service data for each of the POPs 506. The cloud services 512 may be configured to apply the designation rule(s) to the request and the service data to determine or assign the designation for the POPs 506.

As a first example, where the query is generated by a client device 502 located on the East Coast of the United States during a peak hour time duration (e.g., during standard working hours, such as from 8:00 EST-18:00 EST), the query may include a timestamp (e.g., 9:04:10 EST) and data corresponding to the location of the client device 502 (such as coordinates, an IP address associated with the location, the time zone for the timestamp, etc.). Additionally, the first and second POPs 506(1), 506(2) may be located on the East Coast and Central United States, and the third and N-th POP 506(3), 506(N) may be located on the West Coast of the United States and in East Asia. Each of the POPs 506 may have a respective peak hour time duration, which may be defined based on the peak hour time duration and offset by the corresponding geographic location for the corresponding time zone. The cloud services 512 may be configured to receive the query and identify the timestamp for the request (e.g., 9:04:10 EST) and a location of the client device 502 from the query. The cloud services 512 may be configured to identify or determine the service data for POPs 506 across several geographic locations (such as those in the United States and in other countries), which may include, among other data, a POP location, peak hour time duration, off-peak hour time duration, etc. The cloud services 512 may be configured to apply the data extracted from the query and the service data for the POPs 506 to the designation rule(s) determine a designation for the POPs 506. Continuing this example, the cloud services 512 may be configured to assign the first and/or second POPs 506(1), 506(2) a first designation (e.g., a real-time traffic designation). Additionally, since the query is generated during the peak hour time duration for the first and second POP 506(1), 506(2), the cloud services 512 may be configured to assign the third and/or N-th POP 506(3), 506(N) a second designation (e.g., non-real-time traffic designation).

As a second example, where the query is generated by a different client device 502 located on the West Coast of the United States during a peak hour time duration (e.g., during standard working hours, such as from 8:00 PST-18:00 PST), the query may include a timestamp (e.g., 8:57:10 PST) and data corresponding to the location of the client device 502 (such as coordinates, an IP address associated with the location, the time zone for the timestamp, etc.). The cloud services 512 may be configured to receive the query and identify the timestamp for the request (e.g., 9:04:10 EST) and a location of the client device 502 from the query. The cloud services 512 may be configured to apply the data extracted from the query and the service data for the POPs 506 to the designation rule(s) determine a designation for the POPs 506. Continuing this example, the cloud services 512 may be configured to assign the third POP 506(3) a first designation (e.g., a real-time traffic designation). Additionally, since the query is generated during the peak hour time duration for the third POP 506(3), the cloud services 512 may be configured to assign the first, second, and/or N-th POP 506(1), 506(2), 506(N) a second designation (e.g., non-real-time traffic designation).

As a third example, where the query is generated by a client device 502 located on the East Coast of the United States outside of a peak hour time duration, the query may include a timestamp (e.g., 21:04:10 EST) and data corresponding to the location of the client device 502 (such as coordinates, an IP address associated with the location, the time zone for the timestamp, etc.). The cloud services 512 may be configured to apply the data extracted from the query and the service data for the POPs 506 to the designation rule(s) determine a designation for the POPs 506. Continuing this example, the cloud services 512 may be configured to assign the first and/or second POPs 506(1), 506(2) a first designation (e.g., a real-time traffic designation). Additionally, since the query is generated outside the peak hour time duration, the cloud services 512 may not assign any second designation to other POPs 506(3)-506(N), since the first and/or second POPs 506(1), 506(2) may be capable of servicing all traffic between the client device 502 and endpoint 504 during off-peak hours.

The cloud services 512 may be configured to establish, populate, or otherwise generate a session data file 514 responsive to receiving the query from the client device 502. The session data file may include, for example, an address for the POPs 506 (such as an IP address, a URL, etc.) and the designation assigned for each of the POPs 506. The cloud services 512 may be configured to transmit, send, or otherwise provide the session data file 514 to the client device 502.

The session manager 508 may be configured to parse the session data file 514 received by the client device 502 from the cloud services 512. The session manager 508 may be configured to parse the session data file 514 to extract or otherwise identify the address for each of the POPs 506 and the corresponding designation assigned by the cloud services 512 to the POPs 506. The session manager 508 may be configured to establish connections with the POPs 506 using the session data file 514. For example, the session manager 508 may be configured to transmit a session identifier and the designation from the session data file to the addresses from the session data file for each of the POPs 506. The session manager 508 may be configured to transmit the session identifier and the designation as part of a handshake with a respective POP 506, following handshake and establishing a connection, etc. The POPs 506 may be configured to establish corresponding connections with the endpoint 504 and forwarding, transmitting, or otherwise providing the designation for the POP 506 and session identifier to the endpoint 504. The session manager 510 of the endpoint 504 may therefore determine the designation and session identifier for the POPs 506 responsive to the POPs 506 establishing corresponding connections with the endpoint 504 and receiving the designation and session identifier from the POPs 506.

Following establishing the connections between the client device 502 and POPs 506, and POPs 506 and endpoint 504, each of the corresponding connections may be associated with a corresponding designation for the respective POP 506. In the example shown in FIG. 5, the connections to first and second POPs 506(1), 506(2) may be associated with a first designation (e.g., shown as solid lines), and the connections to the third and N-th POPs 506(3), 506(N) may be associated with a second designation (shown as dashed lines).

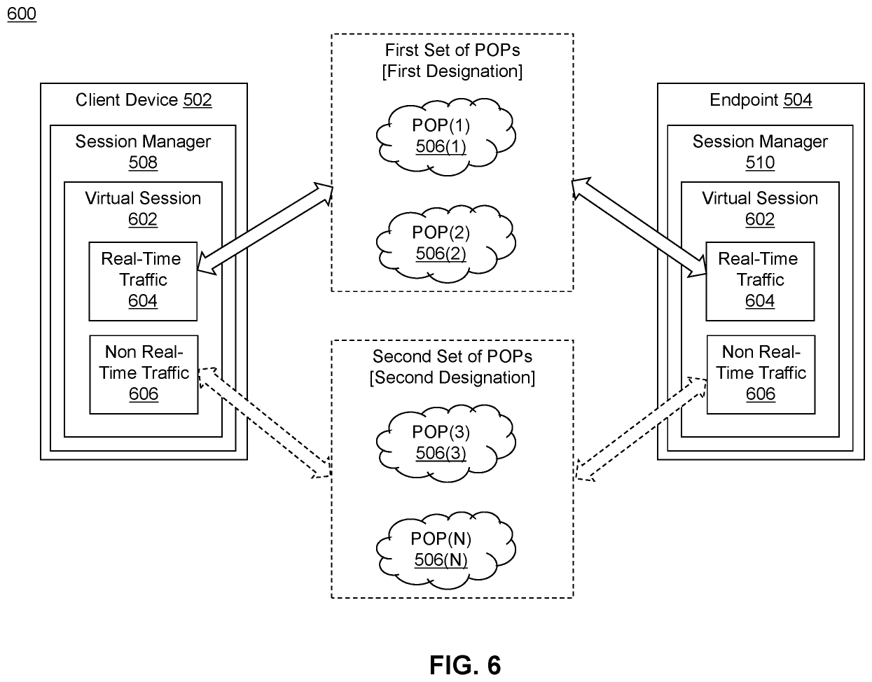

Referring now to FIG. 6, depicted is an example of a computing environment 600 following establishing connections between the client device 502 and endpoint 504, according to an illustrative embodiment. The computing environment 600 shown in FIG. 6 may be generated by the session managers 508, 510 following establishing connections between the POPs 506 as described above with reference to FIG. 5. As shown in FIG. 6, the session managers 508, 510 may establish a first band of connections (shown as solid arrows) with a first set of POPs 506 having the first designation and a second band of connections (shown as dashed arrows) with a second set of POPs 506 having the second designation. The session managers 508, 510 may use the bands of connections for transmitting different types of network traffic for a virtual session 602 between the client device 502 and the endpoint 504.

The virtual session 602 may include different types of network traffic, which may be represented as different types or groups of virtual data units. The session managers 508, 510 may be configured to maintain or otherwise access groupings of data units for defining or categorizing different types of network traffic. For example, the session managers 508, 510 may be configured to maintain groupings of a first set of data units for a first type of network traffic (e.g., real-time network traffic 604, for instance) and a second set of data units for a second type of network traffic (e.g., non-real-time network traffic 606, for instance). The first set of data units may include virtual data units for mouse movements, keyboard interactions, screen refreshes, copy-paste commands, or other units relating to real-time network traffic 604. The second set of data units may include virtual data units for analytics, printer communications, USB communications, file requests, or other units relating to non-real-time network traffic 606. The types of network traffic may be associated with a particular designation for a POP 506. In some embodiments, the session managers 508, 510 may be preconfigured with the different sets of data units grouped by traffic type (e.g., at deployment or instantiation on the client device 502/endpoint 504). In some embodiments, the session managers 508, 510 may be configured to receive the different sets of data units from an administrator computing device. In some embodiments, the session manager 508 of the client device 502 may be configured to receive the different sets of data units from the cloud services 512 (e.g., in the session data file 514, or separate from the session data file 514), and the session manager 508 may share, transmit, send, or otherwise provide the different sets of data units with the session manager 510 of the endpoint 504.

The session managers 508 may maintain one or more band selection rules for associating the designations and types of network traffic. For example, where the computing environment 600 includes connections or bands to POPs 506 having both the first and second designation, a first band selection rule may specify that the first type of network traffic is associated with the first designation and the second type of network traffic is associated with the second designation. However, where the computing environment 600 includes connections or bands to POPs having only the first designation, a second band selection rule may specify that the first and second types of network traffic are both associated with the first designation.

The session managers 508, 510 may be configured to identify network traffic to be transmitted between the client device 502 and endpoint 504. The session managers 508, 510 may be configured to receive the network traffic from a stack of the client device 502/endpoint 504. For example, the session manager 508 of the client device 502 may be configured to identify network traffic of the client device 502 to be transmitted to the endpoint 504, and the session manager 510 of the endpoint 504 may be configured to identify network traffic of the endpoint 504 to be transmitted to the client device 502. The network traffic may include packets which are defined according to respective data units. For example, the network traffic may include data packets corresponding to mouse clicks/movements, graphics, acknowledgements, and so forth. Each of the data packets may include a respective data unit (e.g., a first data unit used for representing a particular mouse click or mouse movement, a second data unit used for representing graphics, etc.).

The session managers 508, 510 may be configured to identify a traffic type for the data packets of the network traffic. The session managers 508, 510 may identify the traffic type by comparing the data unit for the packets to the different sets of data units which are grouped according to a corresponding traffic type. The session managers 508, 510 may be configured to identify, determine, or otherwise select a band of connections to use for transmitting the network traffic based on the traffic type and the corresponding designation. For example, the session managers 508, 510 may apply the identified traffic type to the band selection rules to identify which connections to use for transmitting the packets having the identified traffic type.

The session managers 508, 510 may be configured to select connections from the band of connections to use for transmitting the network traffic. In some embodiments, the session managers 508, 510 may include, maintain, or otherwise access one or more connection selection rules for selecting connections from the band.

In some embodiments, the session managers 508, 510 may access a connection selection rule which specifies all network traffic having the same traffic type is to be sent via a single connection of the corresponding band. The session managers 508, 510 may apply the connection selection rule to each of the bands for the determined traffic types and select a corresponding connection for the respective bands. In this example, and referring back to FIG. 5, the session managers 508, 510 may apply the connection selection rule for a first band including the connections between the first and second POP 506(1), 506(2) and for a second band including the connections between the third and N-th POP 506(3), 506(N). The session managers 508, 510 may select the connections to the first POP 506(1) for the first band and the connections to the third POP 506(3) for the second band. The session managers 508, 510 may send, communicate, or otherwise transmit network traffic having the first type via the selected connection to the first POP 506(1) and network traffic having the second type via the selected connection to the third POP 506(3).

In some embodiments, the session managers 508, 510 may access a connection selection rule which specifies that network traffic having the same traffic type is to be sent via a round robin of the connections for the corresponding band. The session managers 508, 510 may apply the connection selection rule to each of the bands for the determined traffic types and select a corresponding connection for the respective bands for first network traffic. In this example, and referring still to FIG. 5, the session managers 508, 510 may apply the connection selection rule for a first band including the connections between the first and second POP 506(1), 506(2) and for a second band including the connections between the third and N-th POP 506(3), 506(N). The session managers 508, 510 may select the connections to the first POP 506(1) for the first band for a first duration and the connections to the third POP 506(3) for the second band for the first duration. The session managers 508, 510 may send, communicate, or otherwise transmit network traffic having the first type via the selected connection to the first POP 506(1) and network traffic having the second type via the selected connection to the third POP 506(3) for the first duration. Following the first duration, the session managers 508, 510 may select the connections to the second POP 506(2) for the first band for a second duration and the connections to the N-th POP 506(N) for the second band for the second duration. The session managers 508, 510 may transmit network traffic having the first type via the selected connection to the second POP 506(2) and network traffic having the second type via the selected connection to the N-th POP 506(N) for the second duration. Following the second duration, the session managers 508, 510 may select a connection to another POP 506 in the respective bands, or switch back to the POPs 506 used at the first duration.

In some embodiments, the session managers 508, 510 may access a connection selection rule which maps data units of a respective traffic type to a corresponding connection of the band for the traffic type. The session managers 508, 510 may apply the connection selection rule to the data units to select a connection within a particular band for the corresponding traffic type. In this example, and referring still to FIG. 5, the session managers 508, 510 may apply the connection selection rule to map a first data unit (or first set of data units) having the first traffic type to the connections to the first POP 506(1) and a second data unit (or second set of data units) having the first traffic type to the connections to the second POP 506(2). Similarly, the session managers 508, 510 may apply the connection selection rule to map a third data unit (or third set of data units) having the second traffic type to the connections to the third POP 506(3) and a fourth data unit (or fourth set of data units) having the second traffic type to the connections to the N-th POP 506(N). As the session managers 508, 510 identify data units of network traffic to be transmitted between the client device 502 and endpoint 504, the session managers 508, 510 may identify the corresponding bands for the data units, and transmit traffic having particular data units on the associated (e.g., mapped) connection.

In some embodiments, the session managers 508, 510 may be configured to identify metrics for each of the connections within a corresponding band. For example, the session managers 508, 510 may probe each (or a subset) of the connections to determine, detect, or otherwise identify metrics for the connections. The metrics may include, for example, round trip time (RTT) jitter, connection status, etc. The session managers 508, 510 may probe the connections at various intervals. The session managers 508, 510 may be configured to select connections from the bands based on the identified metrics (e.g., select connections having the least RTT, having the least jitter or most stability, etc.). Additionally, the session managers 508, 510 may be configured to switch between connections within a band based on the identified metrics. For example, where a connection which is currently being used by the session managers 508, 510 has an inactive connection status, the session managers 508, 510 may automatically switch from the connection to a different connection within the same band. Once the connection is re-established at a different time, the session managers 508, 510 may be configured to identify a subsequent status (e.g., indicating that the connection is now active) and pool the connection with the other connections in the band for selection as described above.

In some embodiments, the session managers 508, 510 may be configured to exchange various messages with each other for selecting/switching between connections. Additionally or alternatively, the session managers 508, 510 may be configured to receive messages from another source (such as the cloud services 512, an administrator computing device, and so forth). The messages may be defined according to a custom protocol for the virtual session 602. The session managers 508, 510 may exchange or otherwise receive the messages via the POPs 506 to cause the session managers 508, 510 to switch between different connection or otherwise control the flow of traffic.

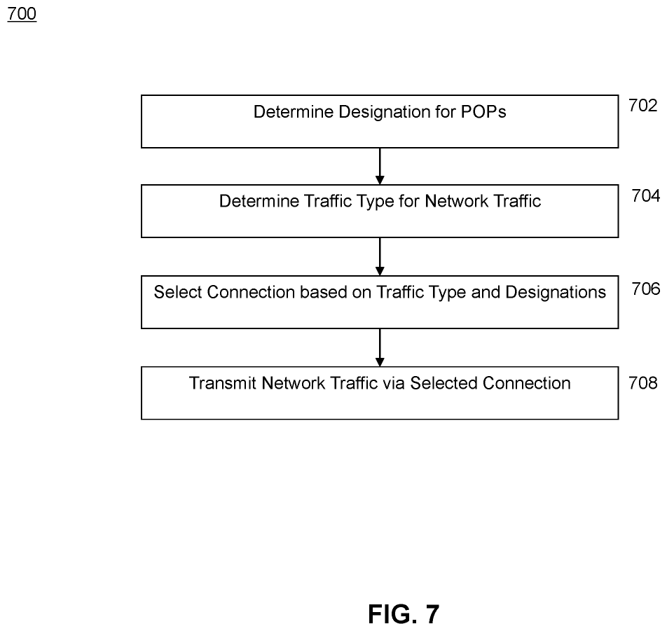

Referring now to FIG. 7, depicted is a flowchart showing a method 700 for real-time data band multi-path routing, according to an illustrative embodiment. The method 700 may be performed by at least some of the components described above with reference to FIG. 1A-FIG. 6, such as the client device 502 and/or the endpoint 504. As a brief overview, at step 702, a device determines a designation for POPs. At step 704, the device determines a traffic type for network traffic. At step 706, the device selects a connection based on the traffic type and designations. At step 708, the device transmits network traffic via the selected connections.

In further detail, at step 702, a device determines a designation for points of presence (POPs). In some embodiments, a client device may determine a first designation for a first POP and a second designation for a second POP. The first POP and the second POP may be intermediary to the client device and an endpoint. The client device may determine the first and second designation based on a data file (such as a session data file) received from a cloud service. The client device may receive the data file from the cloud service responsive to transmitting a query to the cloud service to identify the POPs. The cloud service may generate the data file for the client device. The cloud service may generate the data file responsive to receiving the query from the client device. The cloud service may generate the data file based on data from the query. For example, the cloud service may generate the data file to include designations for the POPs. The cloud service may assign the designations to the POPs based on a timestamp for the query and a location of the client device identified from the query. The cloud service may apply one or more designation rules to the timestamp and location of the client device and service data for the POPs to assign the designations to the POPs. The cloud service may incorporate or otherwise include the designations assigned to the POPs in the data file. The cloud service may transmit the data file to the client device.

The client device may establish a first connection to the first POP and a second connection to the second POP. The client device may establish the first and second connections responsive to receiving the data file. The client device may establish the first and second connections using addresses included in the data file to the first and second POP. In some embodiments, the client device may establish a plurality of first respective connections to a first set of POPs (e.g., having the first designation assigned thereto in the data file by the cloud service) and a plurality of second respective connections to a second set of POPs (e.g., having the second designation assigned thereto in the data file by the cloud service). The client device may transmit the respective designations and a session identifier to each of the POPs to which the client device establishes a connection. The POPs may establish corresponding connections with the endpoint. The POPs may establish corresponding connections with the endpoint responsive to the client device establishing a connection with the POP. The POPs may forward, send, provide, or otherwise transmit the designation of the POP to the endpoint responsive to establishing the corresponding connection with the endpoint.

The endpoint may determine the designation for the POPs. The endpoint may determine the designation for the POPs responsive to receiving the designation from the respective POPs. As such, the designation may be determined first by the cloud service and incorporated in a data file, next by the client device based on the data file, and finally by the endpoint responsive to receiving the designation from the client device via the corresponding POPs.

At step 704, the device determines a traffic type for network traffic. In some embodiments, the client device and/or the endpoint may determine a traffic type for network traffic. In some embodiments, the traffic types may include real-time traffic or non-real-time traffic. The device may determine the traffic type based on data units of packets for the network traffic. Each of the packets may be defined or otherwise generated using a data unit for representing a particular type of data. The devices may maintain or otherwise identify sets of data units for network traffic having different traffic types. The sets of data units may include a first set of data units associated with or having a first traffic type and a second set of data units associated with or having a second traffic type. The device may determine the data units of packets for the network traffic (e.g., based on data from the packets, based on a packet type, etc.). The device may identify the corresponding traffic type for the determined data units for the packets of the network traffic.

At step 706, the device selects a connection based on the traffic type and designations. In some embodiments, the device may select the connection from the first connection to the first POP or the second connection to the second POP. The device may select the connection based on the first designation or the second designation and the network traffic for transmitting to the endpoint. The device may select the connection based on the designation and the determined traffic type for the network traffic. In some embodiments, the device may select the first connection for a first portion of the network traffic having the first traffic type based on the first designation for the first POP and select the second connection for a second portion of the network traffic having the second traffic type based on the second designation for the second POP. In other words, the device may select different connections for different portions of network traffic based on the traffic type for the corresponding portions and the designation of the respective POPs.

In some embodiments, the device may select connections from a band (or plurality) of connections to POPs having a common or shared designation. For example, the device may select connections from a plurality of connections based on one or more metrics of the connection, a connection status of the connection, a round robin of the plurality of connection, or a message to cause the device to switch to the connection. The device may select connections from a band for each of the different types of network traffic.

At step 708, the device transmits network traffic via the selected connections. In some embodiments, the device may transmit network traffic between the client device and the endpoint via the selected connection. In some embodiments, the client device may transmit the network traffic from the client device to the endpoint via the selected connection. Additionally, and in some embodiments, the endpoint may transmit the network traffic from the endpoint to the client device via the selected connection. In other words, the method 700 described herein may be used by both the client device and/or the endpoint to determine designations for POPs, select connections based on determined network traffic types, and transmit network traffic between the client device and the endpoint.

Various elements, which are described herein in the context of one or more embodiments, may be provided separately or in any suitable sub-combination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

What is claimed is:

1. A method comprising:
determining, by a client device, a first designation for a first point of presence (POP) and a second designation for a second POP, the first POP and the second POP intermediary to the client device and an endpoint;
selecting, by the client device, based on the first designation or the second designation and network traffic for transmitting to the endpoint, a first connection to the first POP or a second connection to the second POP; and
transmitting, by the client device, the network traffic from the client device to the endpoint, via the selected first connection or second connection.

2. The method of claim 1, further comprising receiving, by the client device from a cloud service, a data file including the first designation for the first POP and the second designation for the second POP, wherein determining the first designation for the first POP and the second designation for the second POP is based on the data file.

3. The method of claim 1, wherein the network traffic comprises first network traffic having a first traffic type, the method further comprising receiving, by the client device from the endpoint, second network traffic via one of the first connection or the second connection, the endpoint selecting one of the first POP or the second POP based on a second traffic type of the second network traffic.

4. The method of claim 1, further comprising establishing the first connection to the first POP and the second connection to the second POP, wherein establishing the first connection and the second connection comprises:
transmitting, by the client device, a session identifier and the first designation to the first POP, the first POP establishing a corresponding third connection with the endpoint and transmitting the first designation to the endpoint via the third connection; and
transmitting, by the client device, the session identifier and the second designation to the second POP, the second POP establishing a corresponding fourth connection with the endpoint and transmitting the second designation to the endpoint via the fourth connection.

5. The method of claim 4, wherein the endpoint transmits second network traffic via the third connection or fourth connection to the client device based on a second traffic type of the second network traffic.

6. The method of claim 1, wherein the first POP comprises a plurality of first POPs having the first designation and the second POP comprises a plurality of second POPs having the second designation, the method further comprising:
establishing, by the client device, a plurality of first connections to the plurality of first POPs and a plurality of second connections to the plurality of second POPs.

7. The method of claim 6, further comprising selecting, by the client device, the first connection of the plurality of first connections based on at least one of i) one or more metrics of the first connection, ii) a connection status of the first connection, iii) a round robin of the plurality of first connections; or iv) a message to cause the client device to switch to the first connection.

8. The method of claim 1, further comprising:
determining, by the client device, the traffic type of the network traffic; and
selecting, by the client device, the first connection or the second connection for transmitting the network traffic based on the determined traffic type.

9. The method of claim 8, wherein the determined traffic type comprises at least one of real-time network traffic or non-real-time network traffic.

10. The method of claim 1, further comprising:
identifying, by the client device, a first set of data units having a first traffic type and a second set of data units having a second traffic type;
transmitting, by the client device, first data of the network traffic via the first connection based on determining that the first data is of the first set of data units; and
transmitting, by the client device, second data of the network traffic via the second connection based on determining that the second data is of the second set of data units.

11. A client device comprising:
one or more processors configured to:
determine a first designation for a first point of presence (POP) and a second designation for a second POP, the first POP and the second POP intermediary to the client device and an endpoint;
select, based on the first designation or the second designation and network traffic for transmitting to the endpoint, a first connection to the first POP or a second connection to the second POP; and
transmit the network traffic from the client device to the endpoint, via the selected first connection or second connection.

12. The client device of claim 11, wherein the one or more processors are further configured to receive, from a cloud service, a data file including the first designation for the first POP and the second designation for the second POP, wherein determining the first designation for the first POP and the second designation for the second POP is based on the data file.

13. The client device of claim 11, wherein the network traffic comprises first network traffic having a first traffic type, and wherein the one or more processors are further configured to receive, from the endpoint, second network traffic via one of the first connection or the second connection, the endpoint selecting one of the first POP or the second POP based on a second traffic type of the second network traffic.

14. The client device of claim 11, wherein the one or more processors are further configured to establish the first connection to the first POP and the second connection to the second POP, wherein establishing the first connection and the second connection comprises:
transmitting a session identifier and the first designation to the first POP, the first POP establishing a corresponding third connection with the endpoint and transmitting the first designation to the endpoint via the third connection; and
transmitting the session identifier and the second designation to the second POP, the second POP establishing a corresponding fourth connection with the endpoint and transmitting the second designation to the endpoint via the fourth connection.

15. The client device of claim 14, wherein the endpoint transmits second network traffic via the third connection or fourth connection to the client device based on a second traffic type of the second network traffic.

16. The client device of claim 11, wherein the first POP comprises a plurality of first POPs having the first designation and the second POP comprises a plurality of second POPs having the second designation, wherein the one or more processors are further configured to:
establish a plurality of first connections to the plurality of first POPs and a plurality of second connections to the plurality of second POPs.

17. The client device of claim 16, wherein the one or more processors are further configured to select the first connection of the plurality of first connections based on at least one of i) one or more metrics of the first connection, ii) a connection status of the first connection, iii) a round robin of the plurality of first connections; or iv) a message to cause the client device to switch to the first connection.

18. The client device of claim 11, wherein the one or more processors are further configured to:
determine the traffic type of the network traffic, the determined traffic type comprising at least one of real-time network traffic or non-real-time network traffic; and
select the first connection or the second connection for transmitting the network traffic based on the determined traffic type.

19. The client device of claim 11, wherein the one or more processors are further configured to:
identify a first set of data units having a first traffic type and a second set of data units having a second traffic type;
transmit first data of the network traffic via the first connection based on determining that the first data is of the first set of data units; and
transmit second data of the network traffic via the second connection based on determining that the second data is of the second set of data units.

20. A non-transitory computer readable medium storing instructions that, when executed by one or more processors, cause the one or more processors to:
determine a first designation for a first point of presence (POP) and a second designation for a second POP, the first POP and the second POP intermediary to a client device and an endpoint;
select, based on the first designation or the second designation and network traffic for transmitting to the endpoint, a first connection to the first POP or a second connection to the second POP; and
transmit the network traffic between the client device and the endpoint, via the selected first connection or second connection.
